(19) United States
(12) Patent Application Publication
(10) Pub. No.: US 2005/0023820 A1
(43) Pub. Date: Feb. 3, 2005

(54) Reduced sized graph paper

(76) Inventor: Fernando Cardenas, Charlotte, NC (US)

Correspondence Address: ADAM EVANS, P.A.;(formerly Adams, Schwartz & Evans, P.A.), 2180 TWO WACHOVIA CENTER, CHARLOTTE, NC, 28282, US

(21) Appl. No.: 10/633,181

(22) Filed: Aug. 1, 2003

(51) Int. Cl. B42D 1/00

(52) U.S. Cl. 281/38

(57) ABSTRACT

A sheet for writing or drawing thereon includes a sheet of paper sized no greater than four inches by six inches, and having a plurality of lines printed on a surface thereof. The lines are positioned and spaced to form a plurality of squares of equal size covering the surface of the sheet. In another embodiment, a sheet includes a rectangular sheet of paper sized approximately eight and one-half by eleven inches and perforated to form first, second, third, fourth and fifth rectangular sections. The first section is sized approximately two by three and one-half inches, the second and third sections are each sized approximately three by five inches, and the fourth and fifth sections are each sized approximately four by six inches. As such, the sheet can be easily divided into smaller sections according to the needs of the user.

### TECHNICAL FIELD AND BACKGROUND OF THE INVENTION

This invention relates to reduced sized graph paper, particularly graph paper sheets sized to no greater than four by six inches. In addition, the invention provides a pad of 8½ by 11 inch sheets that are perforated into sections of convenient size such as four by six inches, three by five inches and two by three and a half inches.

Graph paper is commonly used by individuals in a variety of professions and fields of study. Graph paper provides added structure for drawing, sketching, accounting, financial record keeping, and creating tables and graphs. Graph paper has been produced in the standard sheet size of 8½ by 11 inches. However, there is a need for the structure provided by graph paper in other convenient smaller sizes.

The rectangular dimensions of four by six inches and three by five inches are sizes commonly used in a variety of items, such as notepads, stationery and photographs. The rectangular dimension of two by three and a half inches is the common size for a business card. Such sizes are convenient for stationery and like items as they can be easily transported in an individual's pocket or purse.

### SUMMARY OF THE INVENTION

Therefore, it is an object of the invention to provide a conveniently sized graph paper sheet.

It is another object of the invention to provide an 8½ by 11 inch sheet that can be easily separated into a plurality of smaller sections, each having predetermined dimensions according to the needs of the user.

These and other objects of the present invention are achieved in the preferred embodiments disclosed below by providing a sheet for writing or drawing thereon comprising a sheet of paper sized no greater than four inches by six inches, and having a plurality of lines printed on a surface thereof. The lines are positioned and spaced to form a plurality of squares of equal size covering the surface of the sheet.

According to one preferred embodiment of the invention, the sheet is sized approximately three inches by five inches.

According to another preferred embodiment of the invention, the sheet is sized approximately four inches by four inches.

According to yet another preferred embodiment of the invention, the sheet is sized approximately two inches by three and a half inches.

According to yet another preferred embodiment of the invention, the squares are sized one-fourth inch by one-fourth inch.

According to yet another preferred embodiment of the invention, a pad for writing or drawing thereon comprises a plurality of bound rectangular sheets of paper sized no greater than four inches by six inches. Each of the sheets has a plurality of lines printed on a surface thereof. The lines are positioned and spaced to form a plurality of squares of equal size covering the surface of the sheets.

According to yet another preferred embodiment of the invention, the plurality of bound sheets of paper are sized approximately three inches by five inches.

According to yet another preferred embodiment of the invention, the plurality of bound sheets of paper are sized approximately four inches by four inches.

According to yet another preferred embodiment of the invention, the plurality of bound sheets of paper are sized approximately two inches by three and a half inches.

According to yet another preferred embodiment of the invention, a sheet for writing or drawing thereon can be separated into a plurality of smaller sheets each having a predetermined size. The sheet includes a rectangular sheet of paper sized approximately eight and one-half by eleven inches and perforated to form first, second, third, fourth and fifth rectangular sections. The first section is sized approximately two by three and one-half inches, the second and third sections are each sized approximately three by five inches, and the fourth and fifth sections are each sized approximately four by six inches.

According to yet another preferred embodiment of the invention, the first, second and third sections are positioned parallel to each other.

According to yet another preferred embodiment of the invention, the fourth and fifth sections are positioned parallel to each other.

According to yet another preferred embodiment of the invention, the sheet has a plurality of lines printed on a surface thereof, the lines positioned and spaced to form a plurality of squares of equal size covering the surface of the sheet.

According to yet another preferred embodiment of the invention, a pad for writing or drawing thereon includes a plurality of bound rectangular sheets of paper sized approximately eight and one-half by eleven inches and perforated to form first, second, third, fourth and fifth rectangular sections. The first section is sized approximately two by three and one-half inches, the second and third sections are each sized approximately three by five inches, and the fourth and fifth sections are each sized approximately four by six inches.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a perspective view of a preferred note pad according to the invention; and

FIG. 2 is a top plan view of a preferred sheet according to the invention.

### DESCRIPTION OF THE PREFERRED EMBODIMENT AND BEST MODE

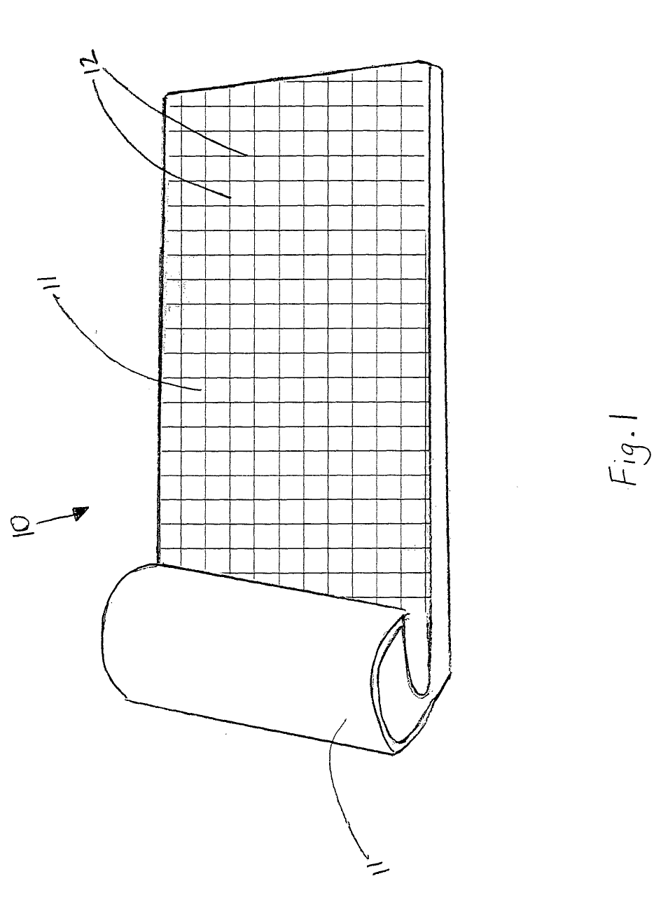

Referring now specifically to the drawings, a preferred note pad according to the present invention is illustrated in FIG. 1, and shown generally at reference numeral 10. The pad 10 comprises a plurality of bound sheets of paper 11. Preferably, each sheet 11 is sized approximately four inches by six inches, and has a series of equally spaced-apart, perpendicular lines printed on its surface forming a plurality of equally sized squares 12. As such, each sheet 11 comprises a sheet of graph paper having a size of approximately four inches by six inches. Preferably, each square 12 is sized one-fourth inch by one-fourth inch. Alternatively, each sheet 11 can be sized three inches by five inches, four by four inches, or two inches by three and one-half inches. In yet another alternative embodiment, the sheet 11 is comprised of hard card.

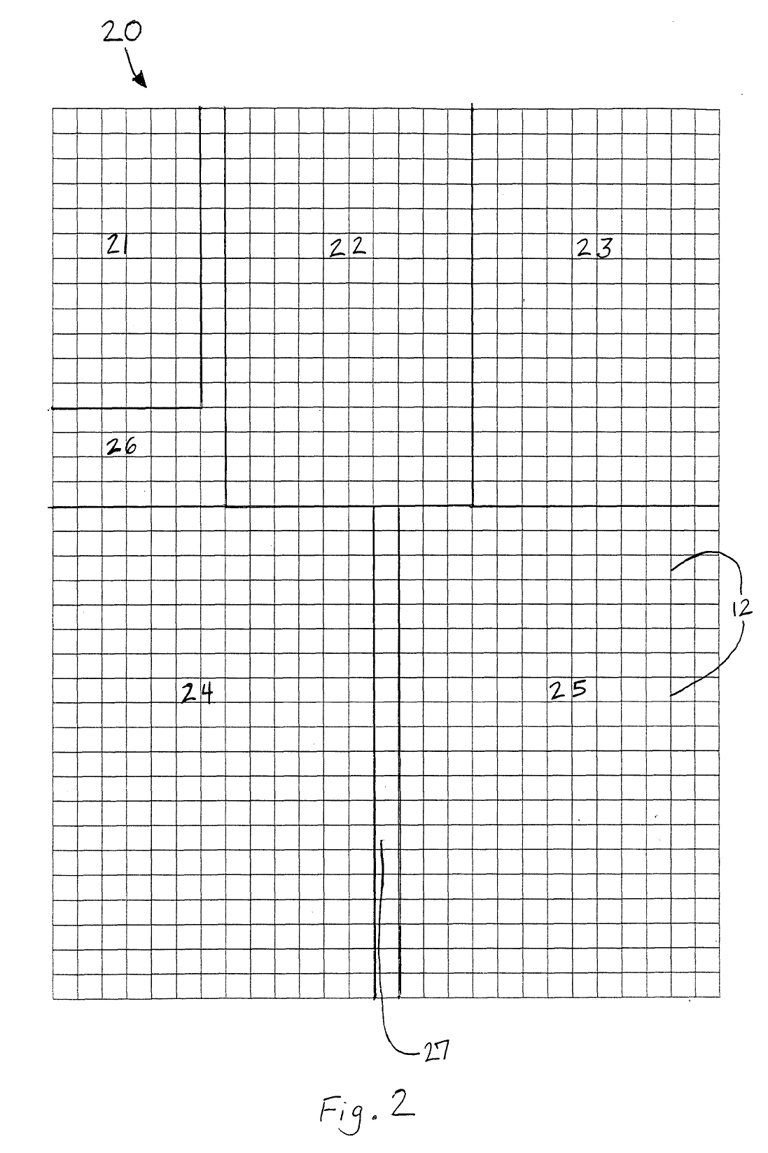

A sheet according to another preferred embodiment of the invention is illustrated in FIG. 2, and shown generally at reference numeral 20. The sheet 20 comprises a sheet of paper sized approximately 8½ by 11 inches, and is perforated into five rectangular sections 21-25. It should be noted that the sheet 20 of FIG. 2 is not drawn to scale. Preferably, three sections 21, 22, 23 are positioned parallel to each other, and longitudinally in the upper portion of the sheet, as shown in FIG. 2. The first section 21 is sized two by three and one-half inches, which is the size of a typical business card. The second section 22 and the third section 23 are each sized approximately three inches by five inches. As such, the combined width of the first section 21, second section 22 and third section 23 is nearly the 8½ inch width of the sheet 21.

The fourth section 24 and fifth section 25 are each four by six inches. Preferably, the fourth and fifth sections 24, 25 are positioned parallel to each other, and longitudinally in the lower portion of the sheet 20. As such, the combined width of the fourth section 24 and fifth section 25 is nearly the width of the sheet 20. The combined height of the fourth section 24 or and the second section 22 is equal to the total length of the sheet 20. Likewise, the combined height of the fifth section 25 and third section 23 is equal to the eight inch length of the sheet 20. A small sixth section 26 is created by the approximate one and a half inches of excess length between the first section 21 and the fourth section 24, and the one-half inch of unoccupied width between the first section 21 and second section 22. Similarly, a small seventh section 27 is formed between sections 24 and 25 by the approximate one-half inch of excess width in the lower portion of the sheet 20.

The sheet 20 preferably has a series of equally spaced-apart, perpendicular lines printed on its surface rendering a plurality of equally sized squares 12 to form graph paper. The sheet 20 provides flexibility to the user by providing graph paper sized in the conventional 8½ by 11 inch size that can be easily divided into other useful sizes such as 2 by 3½ inches, 3 by 5 inches and 4 by 6 inches. In addition, other sizes can be formed by dividing only particular sections. For example, a 6 by 8 inch graph paper sheet can be formed by removing the fourth section 24 and fifth section 25 from the sheet 20, and leaving the fourth and fifth sections 24, 25 connected. Furthermore, the user can select the needed sized section, and leave the remaining for later use.

In an alternative embodiment of the invention, a plurality of sheets 20 are bound together in a single notepad. The sheet 20 is perforated along the edge that is bound together with other sheets to the pad, to allow for easy removal of a single sheet 20 from the pad.

A reduced sized graph paper sheet, a perforated graph paper sheet, and methods for using same are described above. Various details of the invention may be changed without departing from its scope. Furthermore, the foregoing description of the preferred embodiments of the invention and the best mode for practicing the invention are provided for the purpose of illustration only and not for the purpose of limitation—the invention being defined by the claims.

1. A sheet for writing or drawing thereon comprising a sheet of paper sized no greater than four inches by six inches, and having a plurality of lines printed on a surface thereof, said lines positioned and spaced to form a plurality of squares of equal size covering the surface of said sheet.

2. A sheet according to claim 1, wherein said sheet is sized approximately three inches by five inches.

3. A sheet according to claim 1, wherein said sheet is sized approximately four inches by four inches.

4. A sheet according to claim 1, wherein said sheet is sized approximately two inches by three and a half inches.

5. A sheet according to claim 1, wherein the squares are sized one-fourth inch by one-fourth inch.

6. A pad for writing or drawing thereon comprising;
(a) a plurality of bound rectangular sheets of paper sized no greater than four inches by six inches; and
(b) wherein each of said sheets has a plurality of lines printed on a surface thereof, said lines positioned and spaced to form a plurality of squares of equal size covering the surface of said sheets.

7. A pad according to claim 6, wherein said plurality of bound sheets of paper are sized approximately three inches by five inches.

8. A pad according to claim 6, wherein said plurality of bound sheets of paper are sized approximately four inches by four inches.

9. A pad according to claim 6, wherein said plurality of bound sheets of paper are sized approximately two inches by three and a half inches.

10. A pad according to claim 6, wherein the squares are sized one-fourth inch by one-fourth inch.

11. A sheet for writing or drawing thereon that can be separated into a plurality of smaller sheets each having a predetermined size comprising:
(a) a rectangular sheet of paper sized approximately eight and one-half by eleven inches and perforated to form first, second, third, fourth and fifth rectangular sections, and
(b) wherein said first section is sized approximately two by three and one-half inches, said second and third sections are each sized approximately three by five inches, and said fourth and fifth sections are each sized approximately four by six inches.

12. A sheet according to claim 11, wherein said first, second and third sections are positioned parallel to each other.

13. A sheet according to claim 12, wherein said fourth and fifth sections are positioned parallel to each other.

14. A sheet according to claim 11, wherein said sheet has a plurality of lines printed on a surface thereof, said lines positioned and spaced to form a plurality of squares of equal size covering the surface of said sheet.

15. A sheet according to claim 14, wherein said squares are sized one-fourth inch by one-fourth inch.

16. A pad for writing or drawing thereon comprising:
(a) a plurality of bound rectangular sheets of paper sized approximately eight and one-half by eleven inches and perforated to form first, second, third, fourth and fifth rectangular sections, and
(b) wherein said first section is sized approximately two by three and one-half inches, said second and third sections are each sized approximately three by five inches, and said fourth and fifth sections are each sized approximately four by six inches.

17. A sheet according to claim 16, wherein each of said sheets has a plurality of lines printed on a surface thereof, said lines positioned and spaced to form a plurality of squares of equal size covering a surface of each of said sheets.

18. A sheet according to claim 17, wherein said squares are sized one-fourth inch by one-fourth inch.
